(19) United States
(12) Patent Application Publication
(10) Pub. No.: US 2009/0083240 A1
(43) Pub. Date: Mar. 26, 2009

(54) AUTHORIZATION AGNOSTIC BASED MECHANISM

(75) Inventors: Sean Patrick Nolan, Bellevue, WA (US); Johnson T. Apacible, Mercer Island, WA (US); Jeffrey Dick Jones, Woodinville, WA (US); Brian J. Guarraci, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/860,371

(22) Filed: Sep. 24, 2007

(51) Int. Cl. G06F 17/30

(52) U.S. Cl. 707/4; 707/E17.008

(57) ABSTRACT

Systems and methods that provides for an authorization agnostic access in web service environments to privileged information. A query component can specify how a call is to be made to a data store and predefines the data that is retrievable in response to a query defined thereby (e.g., thru HTTPS, Java script, and the like). The query component can employ a plurality of filters that are implemented as part thereof, to customize retrieval for a predetermined portion of the data for a designated period, and encompass an end-to-end scenario from the browser up to the storage.

### BACKGROUND

The emergence of global communication networks such as the Internet and major cellular networks has precipitated interaction between users and other network entities. Today cellular and IP networks are a principal form of communications, and a central means for interacting with other users for various activities. For example, a computing system interfaced to the Internet, by way of wire or wireless technology, can provide a user with a channel for nearly instantaneous access to a wealth of information from a repository of web sites and servers located around the world. Such a system, as well, allows a user to not only gather information, but also to provide information to disparate sources. As such, online data storing and management has become increasingly popular.

This has led to the development of an increasing number of applications designed to operate over an Internet (and/or World Wide Web) connection. Such applications can include functionality such as tracking personal finances by storing information regarding transactions, for example. Such data can include credit card transactions, bank account transfers, and general information such as account numbers, status, authentication used to gather data from a central bank repository, and the like. Accordingly, network users now have mechanisms for searching and or socializing on virtually any topic of interest. Such vast resource of information can also be an impediment for easily locating information as it continues to grow with no end in sight. This presents a formidable challenge when trying to find the information desired; or to locate other users who have similar points of interest.

An example of a network entity that provides social interaction around common subjects is the social network. Social network theory focuses on the relationships and links between individuals or groups of individuals within the network, rather than the attributes of individuals or entities. Generally, a social network can be described as a structure of nodes that represent individuals or groups of individuals (e.g., organizations). Social networking can also refer to a category of network applications that facilitate connecting friends, business partners, or other entities or groups of entities together.

In general, collaborative social networking websites enable users to create remotely stored profiles including personal data such as age, gender, schools attended, graduating class, places of employment, and the like. Such sites subsequently allow other users to search based on designated criteria and try to locate other users; such as finding a companion with similar interests or locate a long lost friend from high school. According to a further example, banking websites enable users to remotely store information concerning bills to be paid. Accordingly, users can automatically schedule bill payments from their bank account, which is then automatically debited when the payment is scheduled. Such allows simultaneous electronic management of account balancing and bill paying that mitigates manual tasks such as entering checks into the register of their checkbook. However, given the already vast amount of information available on such networks, increasing number of new data sources coming online and the differing types of data being provided, interacting with such services can become cumbersome.

For example, complex authentications are typically required in protocol specific ways before information can be accessed. Moreover, sharing of an authorization space is typically not readily supported by non-HTTP GET based communications to access data in storage platforms. Such further limits access to health care related information through portable units.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation provides an authorization agnostic access in web service environments to a user's privileged information, via employing a query component that specifies how a call is to be made to a data store and predefines the data that is retrievable in response to a query defined thereby (e.g., thru HTTPS, java script, and the like). Such query component can employ a plurality of filters that are implemented as part thereof, to customize retrieval for a predetermined portion of the data for a designated period, and encompass an end-to-end scenario from the browser up to the storage. In a related aspect, the query component can generate a URL that corresponds to a query ID. Retrieval of information can then occur based on such query ID employed as part of a table look up to reconstruct and supply the data. The retrieved data can be in form of raw results that can be transformed and rendered as part of a display for a portable unit, which can be carried by a user. Accordingly, relatively simple HTTP GET based mechanisms can be employed that executes predefined query to access data, and mitigates a requirement of complex authentication procedures (e.g., protocol specific).

In a related aspect, the predefined query can be passed among a plurality of third parties, wherein a shared pin can be employed to properly execute the query against the data store of the data platform, and obtain the data that is authorized for retrieval. The data can be dynamic in nature (e.g., blood pressure that requires constant monitoring), wherein the predetermined query can supply continuous access to such dynamic data.

According to a related methodology, initially a query can be defined that includes defining authentication levels for such query, for a formation thereof. Subsequently, third parties can define the query on behalf of the user, who has so granted permission for access to privileged data. Next, by employing the predetermined query authentication and authorization mechanism related to access of data via an associated data platform can typically be mitigated.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a system that employs a query component to supply authorization agnostic access for obtaining data associated with a data platform.

FIG. 2 illustrates a particular block diagram of a query component that can further include a plurality of filters in accordance with an aspect of the subject innovation.

FIG. 3 illustrates a methodology of data retrieval with predetermined queries in accordance with an aspect of the subject innovation.

FIG. 4 illustrates a block diagram for a computer implemented system that facilitates data retrieval in accordance with an aspect of the subject innovation.

FIG. 5 illustrates a related methodology of displaying privileged data by employing predetermined queries in accordance with an aspect of the subject innovation.

FIG. 6 illustrates an artificial intelligence component that interacts with a query component in accordance with an aspect of the subject innovation.

FIG. 7 illustrates a system that facilitates data retrieval by employing a query component when communicating data to/from a health integration network in accordance with an aspect of the subject innovation.

FIG. 8 illustrates a query component that generates predetermined queries to facilitate data retrieval in accordance with an aspect of the subject innovation.

FIG. 9 illustrates an exemplary environment for implementing various aspects of the subject innovation.

FIG. 10 is a schematic block diagram of a sample computing environment that can be employed for data retrieval according to an aspect of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

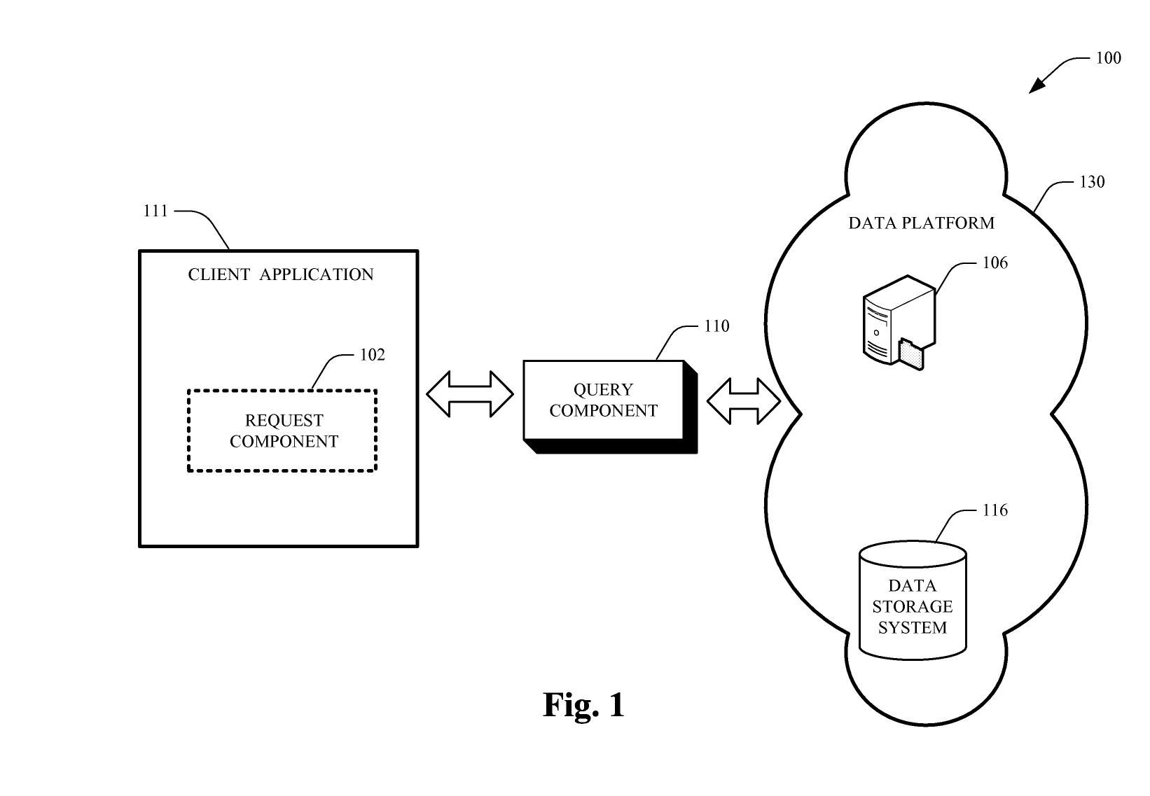

FIG. 1 illustrates a block diagram of a system 100 that provides for authorization agnostic access in a web-service environment to user's privileged information. Such system 100 facilitates data storage and retrieval (e.g., as part of a health integration network), wherein the query component 110 can employ a predetermined query to customize retrieval for a predetermined portion of the data for a designated period, and encompass an end-to-end scenario from the browser up to the storage. Accordingly, the query component 110 can generate a URL that corresponds to a query ID.

The client application 111 can employ a request component 102 can specify a request for data retrieval, data storage, and the like to an API of the data platform 130. Retrieval of information can then occur based on the query ID employed as part of a table look up to reconstruct and supply the data. The retrieved data can be in form of raw results that can be transformed and rendered as part of a display for a portable unit, which can be carried by a user.

The data platform 130 can interpret the request and query a back-end data component 106 based on the request. The back-end data component 106 can then respond to the API, which can return a result to the request component 102, via employing the query component 110. The request component 102 can be any device capable of communicating with the API of the data platform 130. Request generated by the request component 102 can include: requests for storage of data, retrieval of data, modification of data, and any value-add service to the data, addition of data units, retrieval and application of styles and schemas regarding the format of the data, user interface and layout of the data and the like, for example. Accordingly, the API of the data platform 130 can be employed to interpret requests from the request component 102, and facilitate communication with the back-end data component 106. Moreover, requests forwarded by the request component 102 can be in form of calls made via XML over hypertext transfer protocol (HTTP), calls made directly to the API, or calls made to a wrapper around the API or a combination thereof. Employing XML typically enables for an extensible data model where the structure can change and not require new code, for example.

Moreover, the data storage system 116 can include schematized health related data. For example, the data can be an item including a record corresponding to health related data such as a medical diagnosis; the data can come from many sources including an application used at a doctor's office, or a type of automated diagnosis device such as a home pregnancy test. Moreover, data from such different types of sources can be taken and conform to a single schema that is operable in a centralized health integration network. The data stored in the data storage system 116 can also be related to a new application that desires to register with the health integration network. For instance, the data can include information regarding the name of the application, devices able to access the application, authorization rules for data of the applications, different data types defined and useable by the application; this information can be stored according the schema described herein. Moreover, the data can also be other data related to a user, specifically concerning account information, such as user name, password, and the like. Information such as insurance info, medical history, allergies, and the like can be defined as the individual health records described.

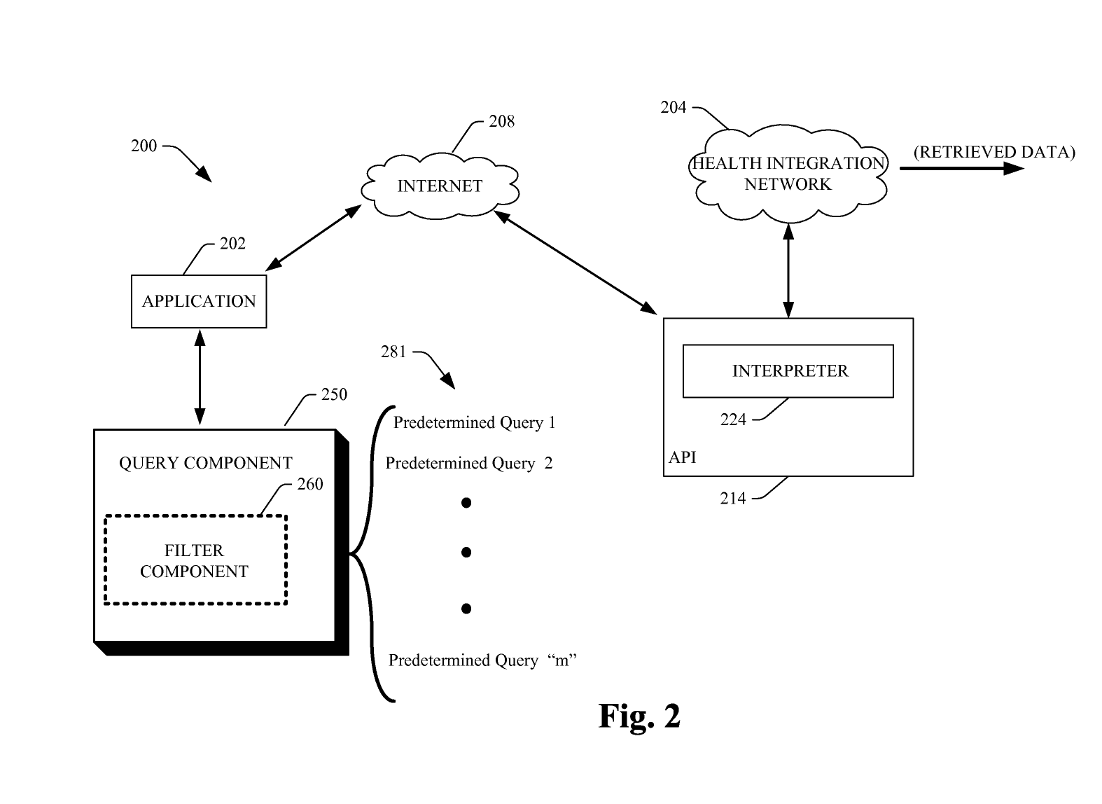

FIG. 2 illustrates a query component 250 that includes a filter component(s) 260 in accordance with an aspect of the subject innovation. The filter component 260 implements filters to customize retrieval for a predetermined portion of the data for a designated period or duration, by designating predetermined queries 281 (1 to m, where m is an integer) and encompass an end-to-end scenario from the browser up to the storage. Such predetermined queries can be passed among a plurality of third parties, wherein a shared pin can be employed to properly execute the query against the data store of the data platform, and obtain the data that is authorized for retrieval. The data can be dynamic in nature (e.g., blood pressure that requires constant monitoring), wherein the predetermined query can supply continuous access to such dynamic data. By constructing a URL, unique identifiers are then returnable via the predefined query, wherein a caller can employ to retrieve data, which can be displayable on a portable unit.

The subject innovation can also implement built in known filter modules in a predetermined query environment that enables callers to further restrict such query. For example, such can employ a known filter module referred to as “topn” to control the number of entries to be returned. Hence, the open query call can be implemented as http://server/openquery.ashx?id=GUIDHERE&topn=20 to limit the returned data to 20 items. It is to be appreciated that other possible filter modules can be employed, such as filters that include dates, time of day, and the like.

In a related aspect, and as further illustrated in FIG. 2, the predetermined query(ies) 281 can relate to a request made to access personal health related data in a health integration network. The predetermined query enables typically open unauthenticated URLs that return the dynamic results of a “canned” query performed within the context of a particular person, record and application. Such open URLs can be employed to integrate with other part sites that need not share a same authorization space. An exemplary predetermined query (e.g., open query) can be created as a record in form of a record that is created in the open queries table, which has the following schema:

```
create table open_queries
(
  open_query_id uniqueidentifier  not null,
  application_id uniqueidentifier  not null,
  person_id uniqueidentifier null,
  header_xml  xml not null,
  info_xml xml not null,
  note varchar(128) null,
  pin_code varchar(128) null,
  date_created  datetime not null,
  expires_minutes int null,
  constraint pk_open_queries primary key nonclustered
  (open_query_id)
  -- note no foreign keys to apps/people ... not important to enforce
);
```

The open_query_id is the unique id that can be employed for identifying a particular open query. Such id typically is considered to be unique across users/applications and can typically be generated automatically by the database. Likewise, the application_id identifies the application that created the OpenQuery, and the person_id identifies the account that created the OpenQuery. Similarly, header_xml specifies the header to be used in conjunction with the query (info_xml and info_xml specifies the actual query that will be executed on the database. The note—comment/note is attached by the OpenQuery creator, and pin_code—if exists, is a PIN used to protect access to the OpenQuery. The date_created indicates the date/time the OpenQuery was created, and expires_minutes indicates lifetime of the OpenQuery in minutes. The open query id is returned to the caller and is used to create a URL http://<server>/openquery.ashx?id=GUIDHERE where <server> is the domain name used by the health integration platform and GUIDHERE is the id that can be returned by the SaveOpenQuery call.

Accordingly, the user can access the predefined query using the URL. When the platform obtains such URL, it looks up the OpenQuery using the id provided. Subsequently, it can construct an internal webservice call using the contents of the header_xml and info_xml. Next, the result of such webservice call can be returned to the user in the form of an XML blob, wherein the blob can be formatted using an XML transform that is could be specified during the OpenQuery creation. Moreover a predetermined query or an OpenQuery can be deleted by a direct deletion using DeleteOpenQuery or it can be deleted by the system when it expires, for example.

As illustrated, the application 202 that makes a request to at least one of retrieve, store, modify, or otherwise access data from a health integration network 204. The request can be sent to the API 214 through the Internet 208 using an HTTP protocol specifying the request in XML format, for example. The API 214 can include an Interpreter 214 to derive the request parameters from the request sent by the application 202. Requests for data can be submitted to the API and can, for example, specify the person ID (if the requesting party is different from the user whose information is sought, for example, a doctor accessing patient records), record ID, an authentication token for the user, a language specification, a country specification, a message creation time and expire time, and/or any parameters required by the method. An exemplary API can include;

SaveOpenQuery

SaveOpenQuery method can be employed for an application to create an open query method. The API allows the creator to specify a timeout period, a note, a PIN number, and the query needed to access the data. For sensitive blobs (privacy), a password-protected-package can serve as an envelope to such blob and contain required information needed to decrypt the blob. Moreover, once the predetermined query (e.g., open query is created), a typical browser can call http://<server>/openquery.ashx?id=GUIDHERE and receive the results of the query.

DeleteOpenQuery

DeleteOpenQuery enables the custodian of a record to delete an existing OpenQuery by specifying an OpenQuery identifier.

GetSaveOpenQueryInfo

GetSaveOpenQueryInfo allows the caller to get basic information on open queries. This allows applications to query relevant information about an OpenQuery (or a list of OpenQueries) to help it and users decide on actions to take. Such API does not typically return the actual OpenQuery or the results of the OpenQuery. For example, the information returned can include data as to whether a pin is required, Expiration date, Creation date, name of the application that created the open query, and the like.

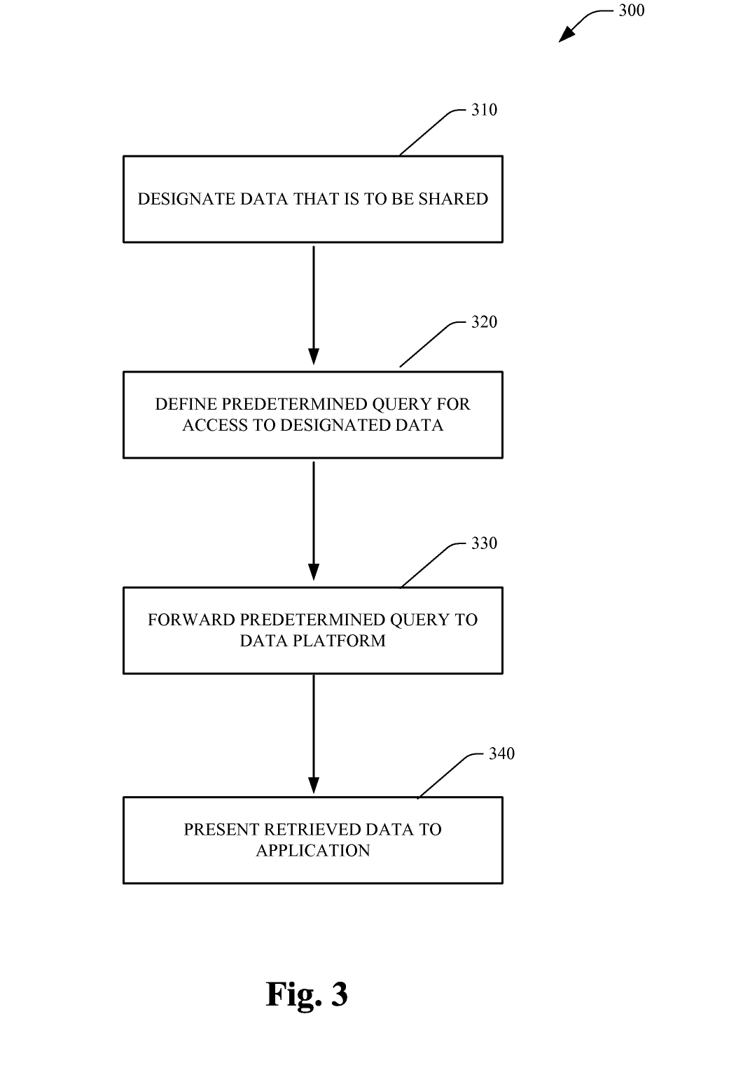

FIG. 3 illustrates a related methodology 300 of data retrieval via an authorization agnostic access in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described.

Initially and at 310 a query can be issued by an application and forwarded to a data store as part of a data platform in a stateless environment. Such stateless environment (e.g., stateless web service or web farm where any request can be forwarded to any server) of the subject innovation typically lacks persisted connections (e.g., lacks an active directory that employs a virtual list and maintenance of states on a server), and hence each request to the server can be considered unique and new with no ties to other requests. Accordingly, a client typically assumes responsibility to maintain contextual information to retrieve any additional information. Next, and at 320 the single request forwarded to the data store of the data platform can be processed to obtain requested data. At 330, the retrieved data can be supplied to the application. Upon review of such retrieved data, the application can decide if addition retrieval of information is required as related to the single request. Accordingly, the methodology 300 can reduce total amount of data transferred at any given portion of the query, and supply an option to retrieve more detailed information related to data requested by the query. Accordingly, an application requesting data thru a query can initially be supplied with a limited number of data, which can be followed by additional data items returned as unique identifiers.

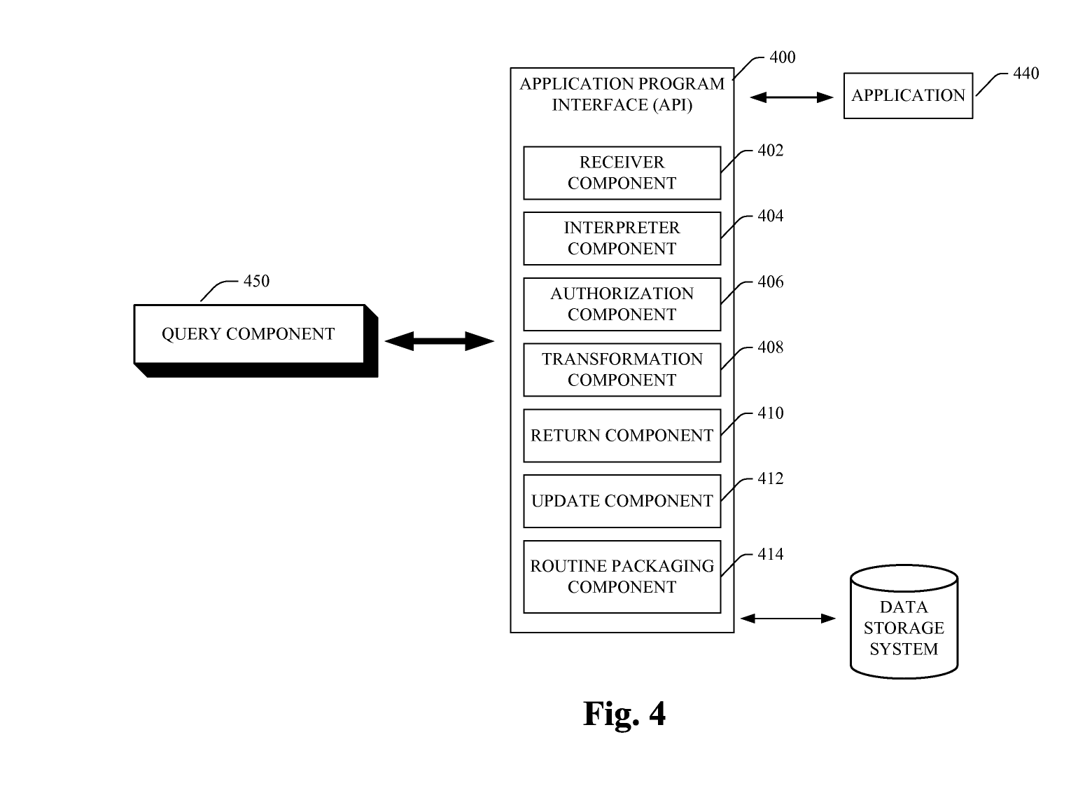

FIG. 4 illustrates an API 400 that can interact with a query component 450 in accordance with an aspect of the subject innovation. The API 400 has various components to facilitate requests to retrieve, store, modify, or otherwise access data in accordance with the described subject matter. For example, the API 400 can have a receiver component 402 that receives requests for data access, an interpreter component 404 that interprets the request and gathers the desired data and any related data and/or metadata (data about the data). The API 400 can also include an authorization component 406 to apply authorization/authentication rules to the requesting entity to ensure it has sufficient access to make the desired request, or that includes the password that accompanies employing the URL created for the predetermined query. The API 400 can have a transformation component 408 that can apply a transformation, translation, style, and/or a schema to the data if desired. The transformation component 408 can also package the resulting data with the appropriate and/or available transformation information so the requesting entity can perform desired transformations. The API 400 can also leverage a return component 410 to send the desired data, as well as any attached data, back to the requesting entity. An update component 412 can enable applications to attach to the API 400, opening a communications channel, and automatically receive updates for information. The API 400 can further provide a routine packaging component 414 for creating intelligent routines to ease use of the API 400.

In a related aspect, when interacting with the API 400, a requesting entity, such as a device, application 440, device running on the application 440, legacy device attached to a system with an application, and the like, can initiate a request for data to the API 400, which is picked up by the receiver component 402. The request can relate to an access personal health and/or fitness related data, for example, such as prescription information. Accordingly, the receiver component 402 can receive the request and sends it to the interpreter component 404. The interpreter component 404 determines the type of request, for example for retrieval of data, storage of data, or modification of data, and determines the record or type being requested. The interpreter component 404 can leverage the authorization component 406 to determine if the requesting entity has sufficient privileges to access the requested data for the type of request presented, and the URL associated with the predetermined query. For example, a party may not have sufficient access to change or even view a medical diagnosis of their spouse. Authorization rules can be set by many parties, including the person to whom the data directly relates, medical professionals, etc. If the entity is denied access, the return component 410 can send a resulting error notification (in XML format, for example) back to the requesting entity.

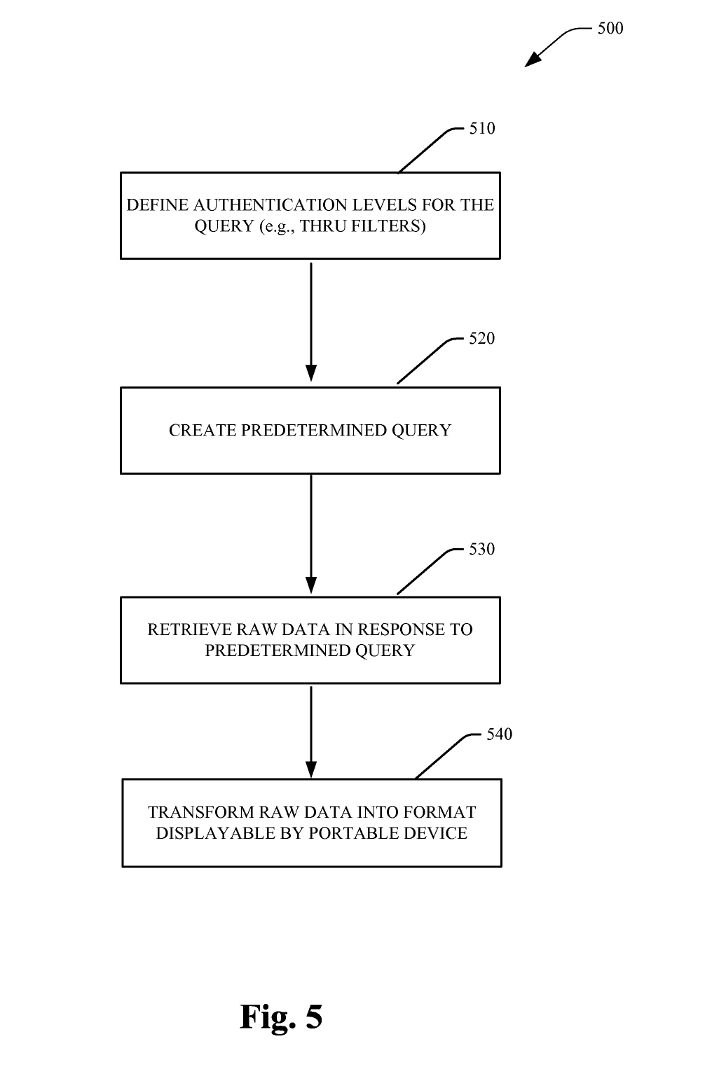

FIG. 5 illustrates a related methodology 500 for a client to craft user experience in form of paged or virtual list of views. Initially and at 510, authentication levels can be defined for a query thru plurality of filters. Next and at 520, a predetermined query can be created based on such predetermined filters. Such predetermined query can then be created that can be shared among various parties to access privileged information about a user. At 530, raw data (e.g., rows and columns) can be retrieved in response to the predetermined query. At 540 such raw data can be transformed into a format displayable by a portable device that can is associated with the application submitting the request to a data store of the data platform.

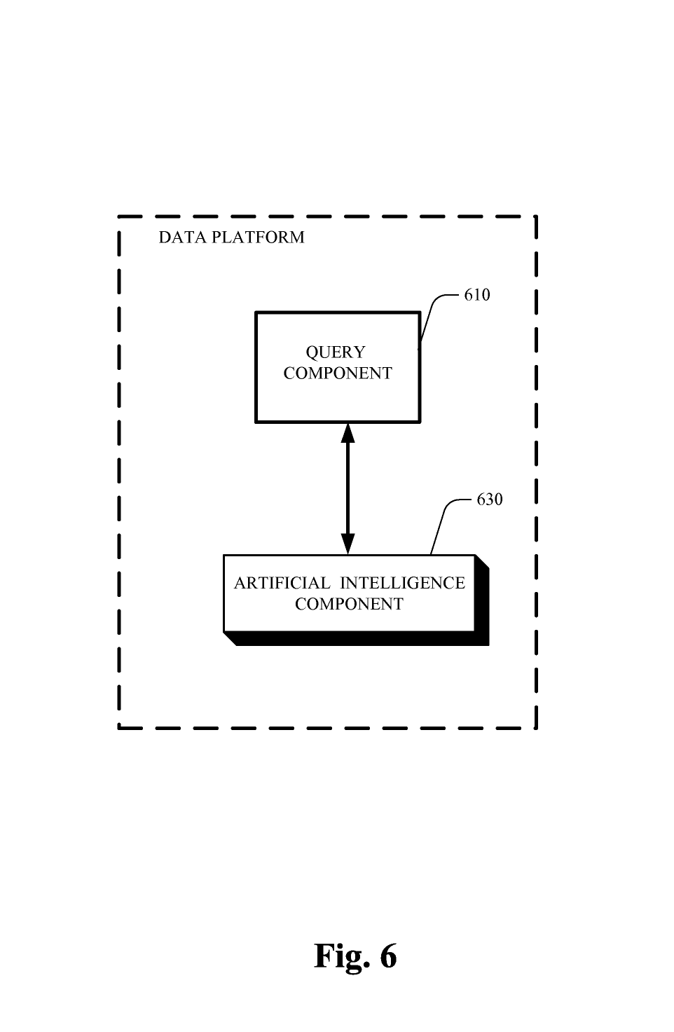

FIG. 6 illustrates an artificial intelligence component (AI) component 630 that can be employed to facilitate inferring and/or determining when, where, how to generate a predetermined query to access a user's privileged information in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 630 can employ any of a variety of suitable AI-based schemes as described supra in connection with facilitating various aspects of the herein described invention. For example, a process for learning explicitly or implicitly how data and predefined queries are to be correlated can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

Accordingly, the query component can generate a URL that corresponds to a query ID. Retrieval of information can then occur based on such query ID employed as part of a table look up to reconstruct and supply the data. The retrieved data can be in form of raw results that can be transformed and rendered as part of a display for a portable unit, which can be carried by a user.

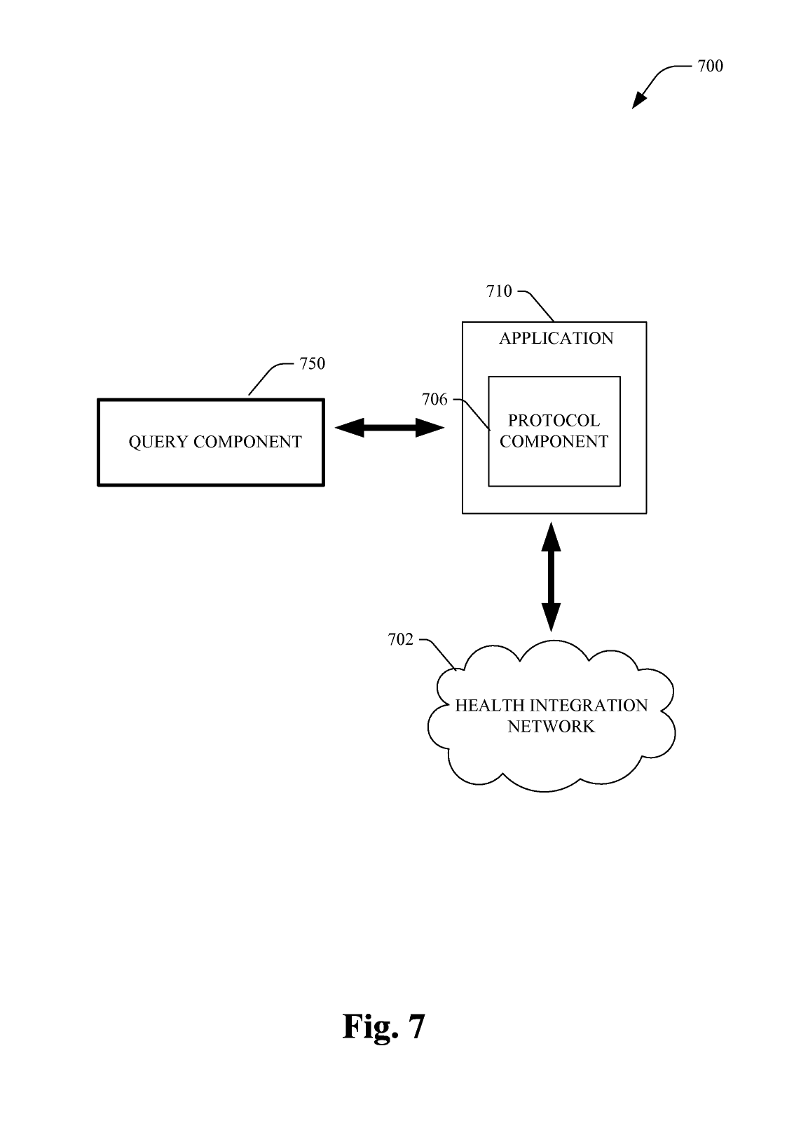

FIG. 7 illustrates a system 700 that facilitates data retrieval thru an authorization agnostic access in a web service environment, when communicating data to/from a health integration network using via employing a query component 750. The application 710 can request data from a health integration network 702. As illustrated, the protocol component 706 can have respective protocol interpretations components that can properly conform the data to the protocol specification by using data envelopes and the like. The application 710 can supply requests to the health integration network 702, for example, to retrieve, store, modify, add value to, or otherwise access personal health related data stored in the health integration network 702.

According to one particular aspect, a protocol component 706 can further specify application 710 specific data within a header of a data envelope for the data, to enable data modification (e.g., edit, write, and the like). The application specific data can include information regarding methods requested, record identifiers for requested data, user ids, and the like. While incrementally receiving the data envelope, the protocol component 708 can extract information from the header and interact with the health integration network 702 to make preliminary decisions regarding the request for data access and/or data modifications. If a decision is made that the request is not desirable, communication can be closed with the application 710 either permanently, temporarily and the like.

Data requested from the application 710 to the health integration network can be to retrieve, store, modify, or otherwise access, for example, data relating to health such as blood pressure readings, insurance information, prescriptions, family history, personal medical history, diagnoses, allergies, X-rays, blood tests, and the like. Additionally, the data can be fitness related, such as exercise routines, exercise goals, diets, virtual expeditions based on exercise routines, competitions, and the like. It is to be appreciated that the protocol component 706 and can be a stand-alone component and/or can at least partially reside within an application or system. For example, the protocol component 706 can be part of the health integration network 702. The query component 750 can generate a URL that corresponds to a query ID. Retrieval of information can then occur based on such query ID employed as part of a table look up to reconstruct and supply the data.

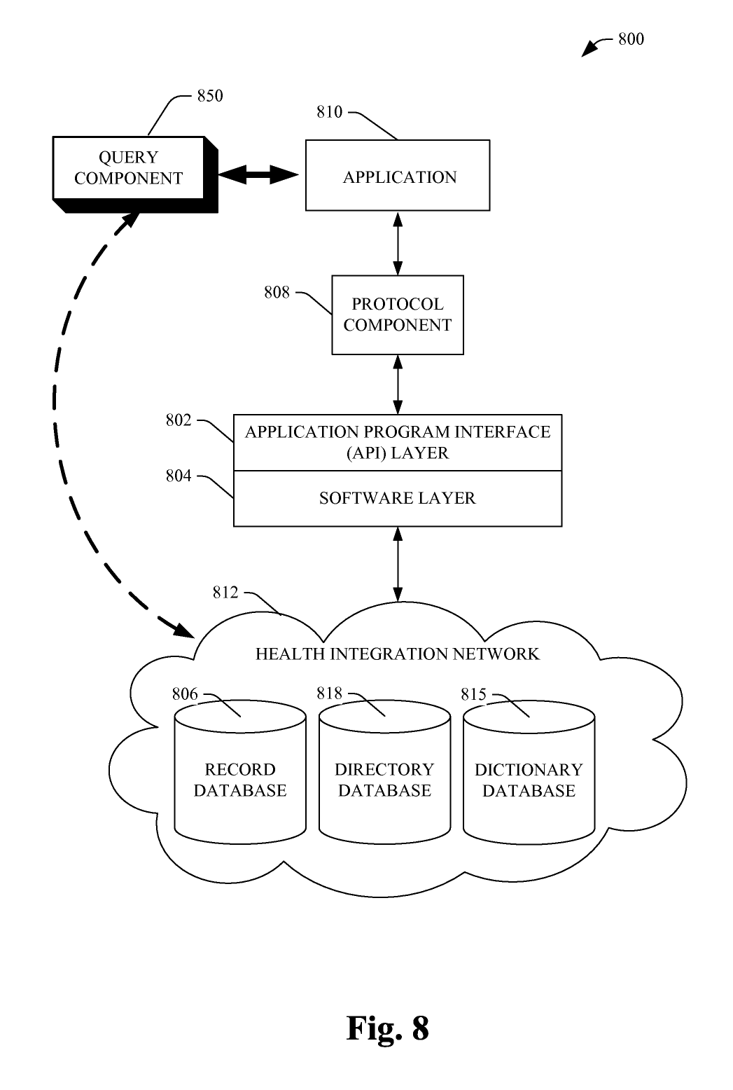

FIG. 8 illustrates a further system 800 of the subject innovation, wherein the query component 850 can supply an authorization agnostic access to the health integration network 812. Accordingly, an application requesting data thru a query can be supplied with the information designated by the user, and hence the system 800 facilitates access of information to a health integration network.

The protocol component 808 can conform request data to a protocol for submission to a remote source such as an API 802. Upon receiving the data content request from protocol component 808, the API 802 can be employed to request and store data within a health integration network 812. It is to be appreciated that the API 802 can synchronously or asynchronously communicate with a plurality of applications 810, through protocol component 808, of similar or different types. The API 802 can also include a software layer 802 to leverage in interpreting and processing the request. The software layer 804 can be separated out as shown, or it can be integrated within the API 802, the health integration network 812, or both. Upon interpreting and processing a request from the application 810, the software layer 804 can access the health integration network 812 for any necessary data or to store necessary data to fulfill the request. The software layer 804 can also provide value-add to the data such as assembling data from the health integration network 812, applying business models or processes in conjunction with data, caching data, and/or applying transformations or additional information to/with the data. It is to be appreciated that there can exist a plurality of APIs 802 and software layers 804 connecting to a centralized health integration network 812, wherein such network can be a single system or distributed across multiple systems, platforms, and the like. The health integration network 812 can comprise a plurality of data stores including a record database 806, a directory database 818, and a dictionary database 810. It is to be appreciated that the health integration network 812 is exemplary in nature and can further comprise other systems and/or layers to facilitate data management and transfer. Furthermore, the databases can be redundant such that multiple versions of the respective databases are available for other APIs and applications and/or a back-up source for other versions of the databases. Additionally, the databases can be logically partitioned among various physical data stores to allow efficient access for highly accessed systems. Moreover, the databases can be hierarchically based, such as XML and/or relationally based. The record database 806 can be highly distributed and comprise personal health related data records for a plurality of users. The records can be of different formats and can comprise any kind of data (single instance, structured or unstructured). Such can include plain data, data and associated type information, self-describing data (by way of associated schemas), data with associated templates (by way of stylesheets for example), data with units (such as data with conversion instructions, binary data), and the like. Moreover, the record database 806 can keep an audit trail of changes made to the records for tracking and restoration purposes. Additionally, any data type or related instances of the foregoing information can be stored in a disparate database such as the dictionary database 810 described infra. The record database 806 can be partitioned, distributed, and/or segmented based on a number of factors including performance, logical grouping of users (e.g. users of the same company, family, and the like).

The directory database 818 can store information such as user account data, which can include user name, authentication credentials, the existence of records for the user, and the like. The directory database 818 can also house information about records themselves including the user to whom they belong, where the record is held (in a distributed record database 806 configuration), and the like. For example, a user can specify that a spouse have access only to the user's fitness related data, and not medical health related data. Accordingly, a user can protect predetermined data while allowing appropriate parties (such as spouse, doctor, insurance company, personal trainer, and the like) or applications/devices (blood pressure machine, pacemaker, fitness watch, and the like) to have access to relevant data. In addition, the directory database 808 can comprise data regarding configuring applications 810 to interact with the health integration network 802. Likewise, applications 810 can be required to register with the health integration network 802, and thus, the application data in the directory database 818 includes the registration information.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

As used in this application, the terms “component”, “system”, are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

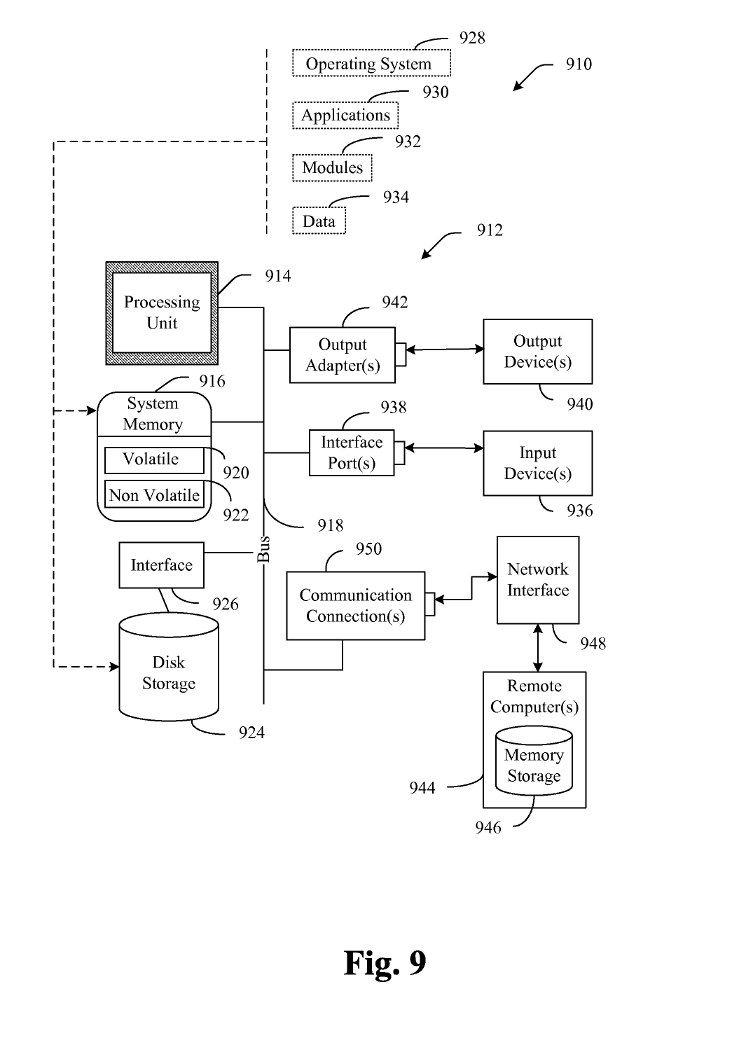

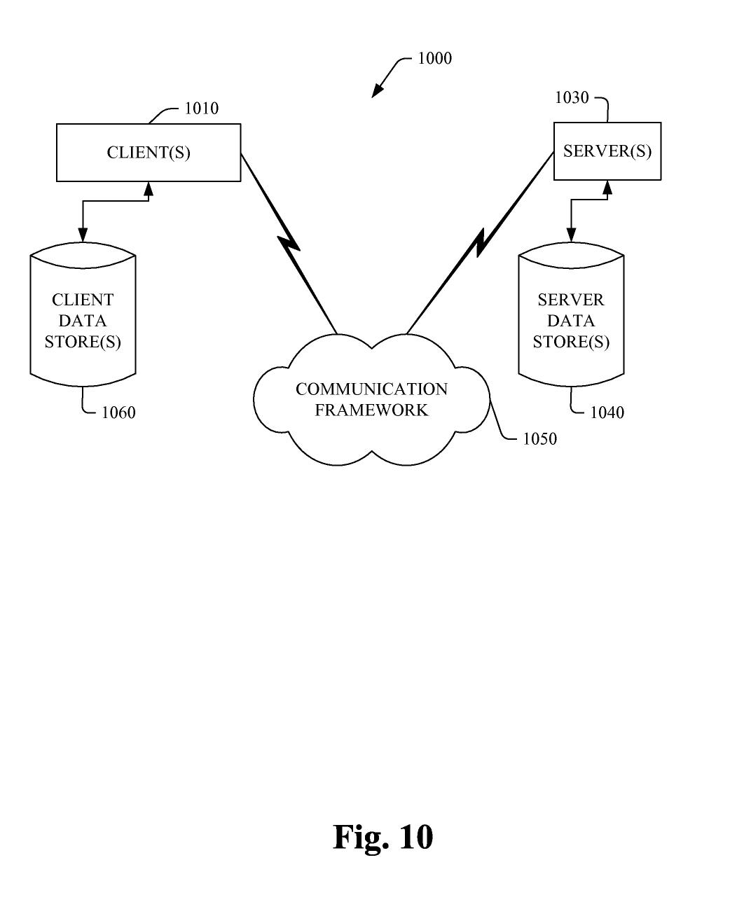

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. For example, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed for implementing data retrieval, in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a data platform that supplies data in response to a predetermined query of an application in web service environment(s); and
a query component that creates the predetermined query for authorization agnostic access to the data platform.

2. The computer implemented system of claim 1 further comprising a URL that supplies the authorization agnostic access.

3. The computer implemented system of claim 1 further comprising a plurality of filter components that facilitate creation of the predetermined query.

4. The computer implemented system of claim 2 further comprising query IDs that identify the predetermined query to a look up table for data retrieval.

5. The computer implemented system of claim 1 further comprising a request component as part of a client application that interacts with the query component.

6. The computer implemented system of claim 5 further comprising an application program interface that interacts with the query component.

7. The computer implemented system of claim 6, the application program interface further comprising an interpreter component that determines type of request by an application.

8. The computer implemented system of claim 7 further comprising an authorization component that determines privileges to the data.

9. The computer implemented system of claim 8 further comprising an artificial intelligence component that facilitates data retrieval by the query component.

10. A method of retrieving data comprising:
supplying authorization agnostic access to privileged information via a predetermined query; and
predefining data that is retrievable by the predetermined query.

11. The method of claim 10 further comprising employing a URL to access the data.

12. The method of claim 10 further comprising designating data that is to be shared.

13. The method of claim 10 further comprising retrieving the data in a raw format.

14. The method of claim 13 further comprising transforming the raw format into a format displayable by a portable device.

15. The method of claim 14 further comprising submitting the predetermined query to a health integrated data platform.

16. The method of claim 11 further comprising sharing the URL among third parties.

17. The method of claim 11 further comprising associating a password with the URL.

18. The method of claim 11 further comprising inferring data retrieval based on classifiers for the predetermined query.

19. The method of claim 11 further comprising defining the predetermined query thru HTTPS, or java script.

20. A computer implemented system comprising the following computer executable components:
issuing means for issuing a query; and
means for accessing a data store associated with a data platform in an authorization agnostic manner thru the query.
